(19) United States
(12) Patent Application Publication
(10) Pub. No.: US 2010/0304796 A1
(43) Pub. Date: Dec. 2, 2010

(54) Magnetic Shield

(75) Inventors: Josef Stohr, Langenau (DE); Andreas Fromel, Ulm (DE); Christian Mayer, Ulm (DE)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/515,345

(22) PCT Filed: Nov. 23, 2006
(86) PCT No.: PCT/EP06/11226

§ 371 Date: Jun. 15, 2010

(51) Int. Cl. H04W 88/02; H04R 11/02

(52) U.S. Cl. 455/575.1; 381/396

(57) ABSTRACT

A mobile apparatus includes an internal hands-free loudspeaker and a magnetic shielding plate that protects external objects sensitive to magnetic fields from the high-level magnetic field generated by the loudspeaker.

### FIELD OF THE INVENTION

The present invention relates to a magnetic shield for protecting objects from a magnetic field of a loudspeaker, in particular from a magnetic field of a loudspeaker in a mobile apparatus.

### BACKGROUND OF THE INVENTION

Mobile apparatuses, such as mobile phones have in recent years become thinner due to market demand and technical advances. When the mobile apparatus is thin, any internal loudspeaker is unavoidably placed relatively close to the outer surface of the mobile apparatus. The combination of the small distance between the loudspeaker and the outer surface of the mobile apparatus and the use of powerful internal loudspeakers with strong magnets can result in unacceptable high magnetic field strength levels at the outside of the mobile apparatus. The high-strength magnetic field could cause damage in objects such as paper-based magnetic cards (hotel keys, carpark cards, credit cards, etc.) or hard disks in other devices that get into close range of the mobile apparatus.

### DISCLOSURE OF THE INVENTION

On this background, it is an object of the present invention to provide a mobile apparatus in which the above drawbacks are overcome or at least reduced. This object is achieved by providing a mobile apparatus comprising a housing with outer walls, a speaker placed inside the housing with the front of the loudspeaker facing one of the outer walls, and a magnetic shielding plate disposed between the loudspeaker and the one outer wall.

This construction allows a much thinner mobile apparatuses that contain high-performance loudspeakers whilst maintaining reasonably low external magnetic field strength.

The magnetic shielding plate may comprise one or more openings allowing passage of the sound produced by the loudspeaker. It has been observed that the required openings do not substantially reduce the shielding effect of the magnetic shielding plate, and thus the sound produced by the speaker can be passed to the exterior directly.

The magnetic shielding plate may be arranged symmetrically relative to the magnetic field of the loudspeaker. Thus, the loudspeaker remains balanced and it can be avoided that its membrane is placed skewered. Also the openings maybe arranged in symmetrically relative to the magnetic field of the loudspeaker.

The magnetic shielding plate can be made from an alloy comprising Ni and Fe. The shielding plate alloy may comprise 40 to 55% by weight Ni with the rest of the alloy being formed by Fe.

The apparatus may further comprise a rear magnetic shielding plate placed on the opposite side of the loudspeaker relative to the magnetic shielding plate. This construction allows the rear side of the speaker to be placed close to an outer wall of the housing of the apparatus whilst maintaining acceptable external magnetic field level strength. Thus, the mobile apparatus can assume a thickness that is relatively close to the thickness of the loudspeaker at whilst maintaining acceptable magnetic field strength levels at the exterior of the mobile apparatus.

The apparatus may further comprise circuitry for generating a signal to drive the loudspeaker, the circuitry being configured to increase the strength of the signal to substantially offset a reduction in the magnetic field strength of the loudspeaker caused by the presence of the magnetic shielding plate.

The magnetic shielding plate may be an integral part of one of the outer walls of the housing.

The housing may comprise one or more cover parts and the magnetic shielding plate can be an integral part of one of the covers.

It is another object of the invention to provide a user removable cover for a mobile apparatus, said cover comprising an integral magnetic shielding plate.

It is another object of the invention to provide a magnetic shielding plate for shielding the magnetic field of a loudspeaker, wherein the magnetic shielding plate is made of an alloy comprising 40 to 55% by weight Ni with reminder being Fe.

Thus, a highly effective shielding means is provided for shielding magnetic fields generated by speakers.

It is another object of the present invention to provide a magnetic shielding plate for shielding the magnetic field of a loudspeaker with least one opening allowing passage of the sound produced by the loudspeaker.

Thus, an effective shielding means is provided that simultaneously allows easy passage of sound to the exterior. Surprisingly, it was found out that the introduction of openings in the loudspeaker shield does not substantially reduce its shielding effect.

The magnetic shielding plate may comprise a plurality of openings allowing passage of the sound produced by the loudspeaker, the plurality of openings being symmetrically distributed over the magnetic shielding plate.

It is another object of the present invention to provide a use of a magnetic shielding plate for shielding a magnetic field of a speaker, wherein the magnetic shielding plate is made of an alloy comprising 40 to 55% by weight Ni with reminder being Fe.

It is yet another object of the present invention to provide a method for shielding a magnetic field that is generated by a speaker in a mobile apparatus having a housing with outer walls, comprising placing a magnetic shield between the speaker and one of the outer walls.

Further objects, features, advantages and properties of the apparatus, shields, use and method according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a front view of a mobile apparatus according to an embodiment of the invention,

FIG. 2 is a side view of the mobile apparatus of FIG. 1,

FIG. 3 is a rear view of the mobile apparatus of FIG. 1,

FIG. 4 is a block diagram illustrating the general architecture of the mobile apparatus of FIG. 1,

FIG. 5 is a cross-sectional view in detail of the mobile apparatus of FIG. 1,

FIG. 6 is an elevational view of the mobile apparatus of FIG. 1 with the rear cover removed,

FIG. 7 is a cross-sectional view in detail of a mobile apparatus according to another embodiment of the invention,

FIG. 8 is a cross-sectional view in detail of another embodiment of the invention,

FIG. 8a is an elevated view of the magnetic shielding plate of the embodiment shown in FIG. 8, and

FIG. 9 is an elevated view of yet another embodiment of a magnetic shielding plate according to the invention.

### DETAILED DESCRIPTION OF PREFERRED EMBODIMENTS

In the following detailed description, the device and the method according to the invention in the form of a personal computer, PDA, mobile terminal or a mobile communication terminal in the form of a cellular/mobile phone will be described by the preferred embodiments.

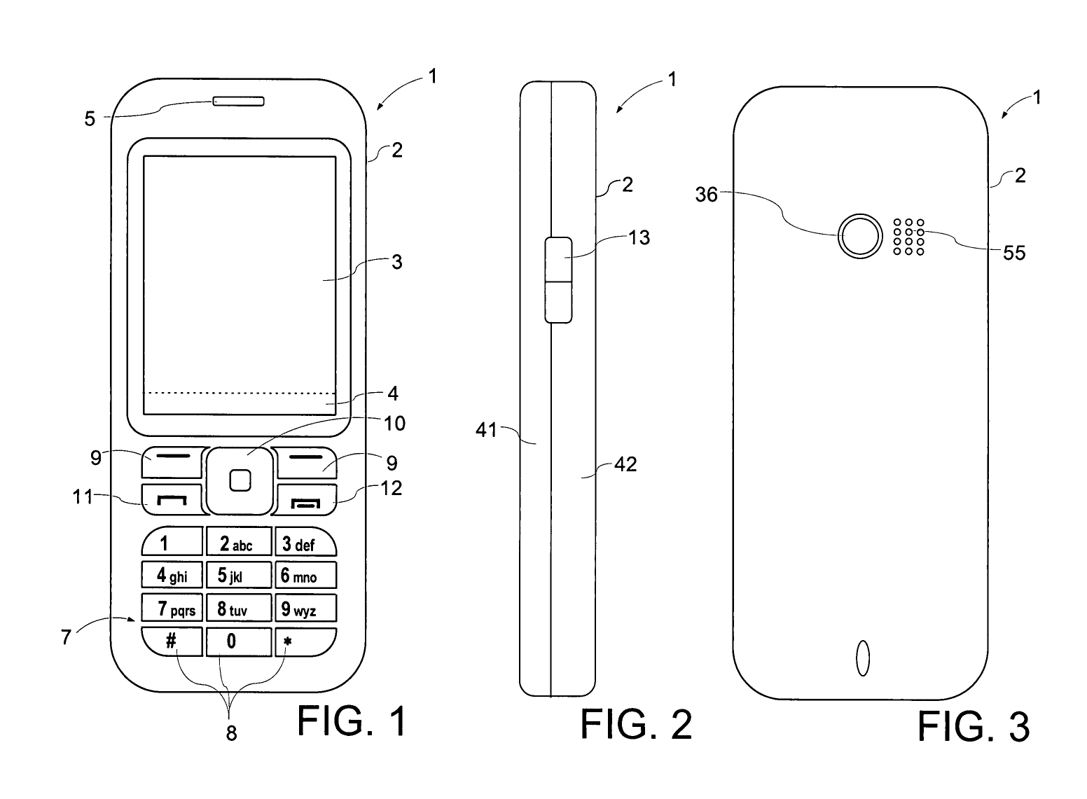

FIGS. 1,2 and 3 illustrate an embodiment of a mobile terminal according to the invention in the form of a mobile telephone by a front view, a side view and a rear view, respectively. The mobile phone 1 comprises a user interface having a housing 2, a display 3, an on/off button (not shown), a speaker 5 (only the opening is shown), and a microphone 6 (not visible in FIG. 1). The mobile phone 1 also includes an internal hands-free loudspeaker 25 (not visible in FIG. 1) of which the openings 55 can be seen in FIG. 3. The mobile phone 1 is also provided at its rear side with a digital camera 36. The housing 2 includes a front cover 41 and a rear cover 42. The front cover 41 and the rear cover 42 form in combination the front, rear and side, top and bottom walls of the housing 2.

According to an embodiment, the mobile phone 1 is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 2 has additionally a second group of keys comprising two softkeys 9, two call handling keys (offhook key 11 and onhook key 12), and a 5-way navigation key 10 (up, down, left, right and center: select/activate). The function of the softkeys 9 depends on the state of the phone, and navigation in the menu is performed by using the navigation-key 10. The present function of the softkeys 9 is shown in separate fields (soft labels) in a dedicated area 4 of the display 3, just above the softkeys 9. The two call handling keys 11,12 are used for establishing a call or a conference call, terminating a call or rejecting an incoming call.

The navigation key 10 is a four- or five-way key which can be used for cursor movement, scrolling and selecting (five-way key) and is placed centrally on the front surface of the phone between the display 3 and the group of alphanumeric keys 7.

The releasable rear cover 42 gives access to the SIM card (not shown), and the battery pack (not shown in FIGS. 1-3) in the back of the mobile phone 1 that supplies electrical power for the electronic components of the mobile phone 1.

The mobile phone 1 has a flat display 3 that is typically made of an LCD with optional back lighting, such as a TFT matrix capable of displaying color images. A touch screen may be used on top of the conventional LCD display.

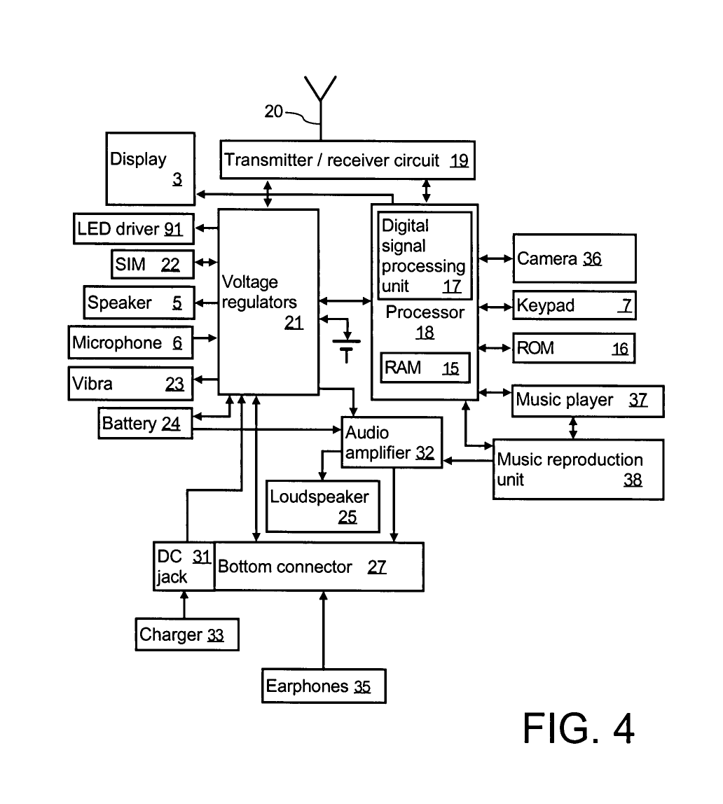

FIG. 4 illustrates in block diagram form the general architecture of the mobile phone 1 constructed in accordance with the present invention. The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 91 (for the LEDS backlighting the keypad 7 and the display 3), the SIM card 22, the vibra 23 battery 24, the bottom connector 27 (for connecting the headphones 35), the DC jack 31 (for connecting to the charger 33) and the audio amplifier 32 that drives the hands-free loudspeaker 25.

The processor 18 also forms the interface for some of the peripheral units of the device, including a (Flash) ROM memory 16, the graphical display 3, the keypad 7, the digital camera 36, a music player 37 and a music reproduction unit 38.

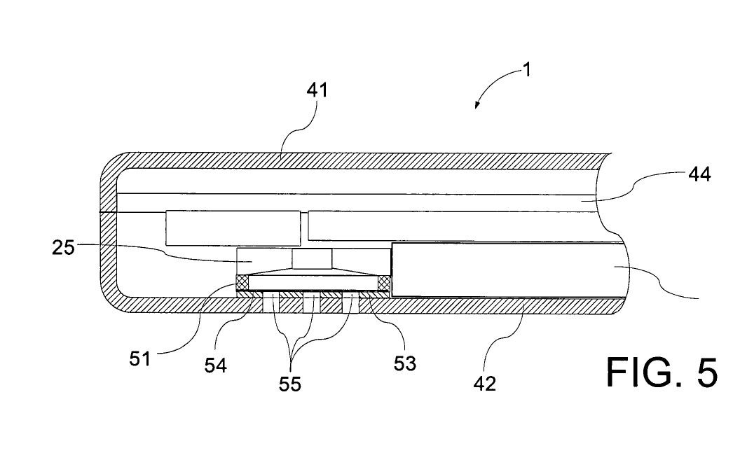

FIG. 5 shows the hands-free loudspeaker 25 and the components in the vicinity of the hands-free loudspeaker in greater detail in a cross-sectional view. A printed wired board 44 carries various components of the mobile phone 1. The battery 24 is placed between the printed wired board 44 and the rear cover 42. The hands-free loudspeaker 25 is placed beside the battery 24, with their respective side services aligned.

The hands-free loudspeaker 25 is placed with its membrane facing the rear outer wall of the mobile phone 1, which is formed in the rear cover 42. A gasket 51 (preferably made from a plastic or rubber foam) is placed between the periphery of the loudspeaker 25 and the outer rear wall of the mobile phone 1. The gasket 51 is provided with a large central opening that allows the sound waves produced by the loudspeaker 25 to pass unhindered. A net 54 that prevents dust from entering into space in front of the loudspeaker membrane is placed between the gasket 51 and the rear wall of the mobile phone 1. A magnetic shielding plate is also placed between the loudspeaker 25 and the rear wall of the mobile phone 1. Preferably, the magnetic shielding plate is placed between the gasket 51 and the rear wall, with the dust net 54 in between the magnetic shielding plate to 53 and the gasket 51. The magnetic shielding plate is provided with a plurality of openings 55 that allow the sound waves generated by the loudspeaker to pass through on their way to the exterior of the mobile phone 1. The rear wall of the mobile phone 1 is provided with matching openings that are for practical reasons also referred to by a reference 55.

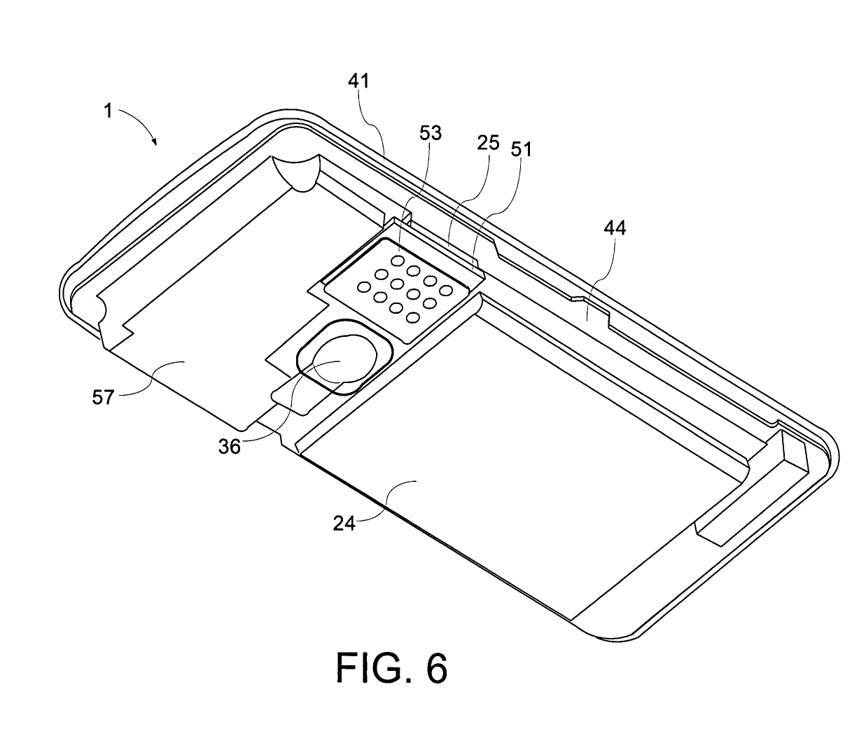

FIG. 6 shows the loudspeaker 25 and the surrounding components of the mobile phone in an elevational view. In FIG. 6 it can be seen that an antenna chamber 57 and the camera 36 border the loudspeaker 25.

The magnetic shielding plate 53 is in an embodiment made from an alloy comprising Ni (Nickel) and Fe (iron), in particularly an alloy comprising 40 to 55% by weight Ni with the major part or all of the remainder of the alloy being Fe. A suitable material for the magnetic shielding plate is PERMENORM 5000V5® that is available from the company VACUUMSCHMELZE GmbH & Co. KG in Hanau, Germany. PERMENORM 5000V5® consists of approximately 47.5% by weight Ni with the rest being mainly or completely Fe.

The presence of magnetic shielding plate 53 reduces the sensitivity of the loudspeaker 25, due to the effect of the shielding plate 53 on the magnetic field of the speaker 25. In order to compensate for the reduction in sensitivity the audio amplifier 32 is configured to increase the strength of the signal to the loudspeaker 25 accordingly, or at least as far as possible. For the same reason, the magnetic shielding plate 53 is placed symmetrically relative to the magnetic field of the hands-free loudspeaker 25, to avoid the effect of an asymmetrical magnetic field on the actuation force of the loudspeaker 25. The placement of the openings 55 is taken into account for obtaining the required symmetry of the magnetic shielding plate 53 relative to the loudspeaker 25, i.e. the magnetic shielding plate 53 with the openings 55 is arranged symmetrical relative to the loudspeaker 25 so that the distortion of the magnetic field of the loudspeaker is balanced and does not unduly reduce the performance of the loudspeaker.

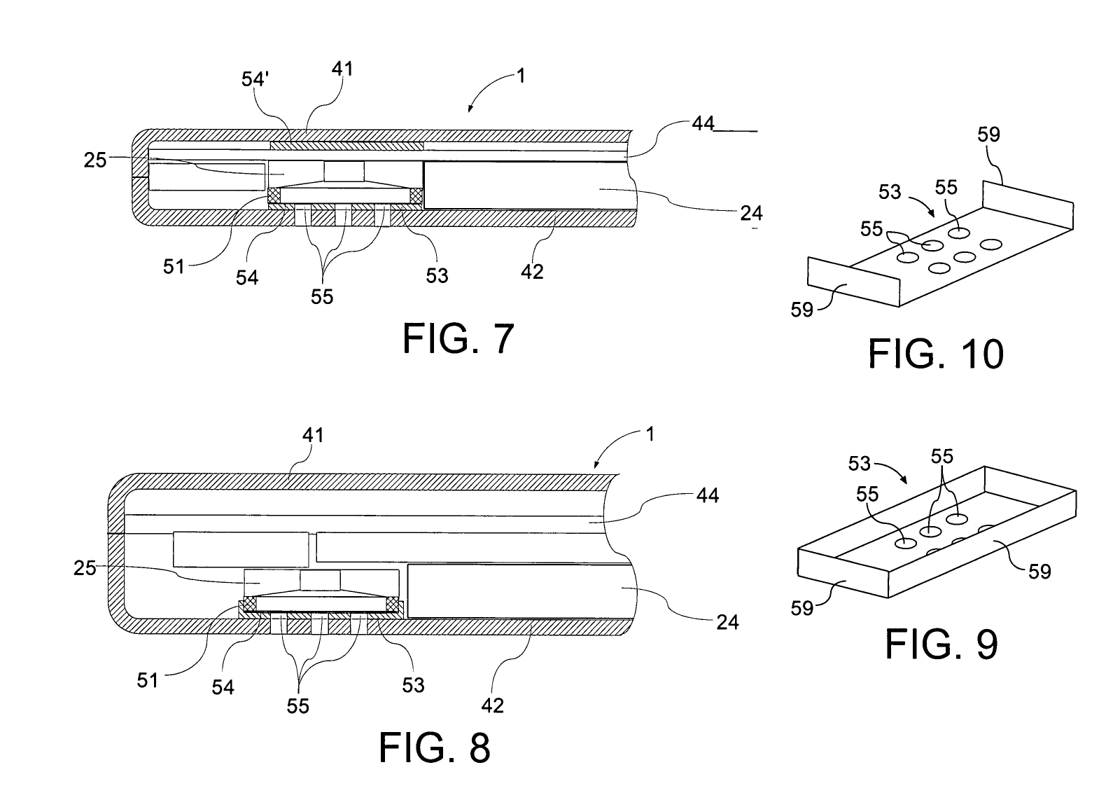

FIG. 7 illustrates another embodiment of the invention in the form of a very thin mobile phone 1, by a cross-sectional view in detail. The mobile phone 1 according to his embodiment is essentially identical to the mobile phone of FIG. 1, except that it is substantially thinner. This means that the distance between the rear of the loudspeaker 25 and the front wall of the mobile phone 1 is relatively small and therefore the magnetic field of the loudspeaker 25 at the front wall is so high that a magnetic shielding is required for protecting objects that are sensitive to magnetic fields that may come in the vicinity of the front wall of the mobile phone 1. Thus, a second magnetic shielding plate 54′ is provided between the front wall (part of the front cover 41) and the rear of the loudspeaker 25. The printed wired board 44 is placed between the second magnetic shielding plate 54′ and the loudspeaker 25. However, the printed wired board does not need to extend over the full length of the phone and could be replaced by a flexible printed circuit in part or whole. The second magnetic shielding plate 54′ does not need to be provided with openings for allowing the passage of sound waves generated by the loudspeaker. However, the second magnetic shielding plate 54′ can be provided with openings for other purposes without losing its magnetic shielding capacity.

In an embodiment (not shown), the magnetic shielding plate 54 or both the magnetic shielding plate 54 and the second magnetic shielding plate 54′ are integrated into the walls of the housing 2, e.g. in to the cover of the mobile phone 1.

In yet another embodiment (not shown), the magnetic shielding plate is integrated in the loudspeaker on integral part of the loudspeaker.

FIG. 8 shows another embodiment of the mobile apparatus 1. This embodiment is essentially the same as the embodiment described in FIGS. 1-6 except that the magnetic shielding plate 53 different. The magnetic shielding plate 53 of this embodiment is shown in more detail in FIG. 9. The magnetic shielding plate 53 is provided at its edges with four ledges 59 to form a rim. The ledges 59 may further improve the magnetic shielding effect and provide more form stability for the magnetic shielding plate.

FIG. 10 shows another embodiment of the magnetic shielding plate 53 that is essentially identical with the magnetic shielding plate of FIG. 9, however, only two opposite edges of the magnetic shielding plate 53 are provided with ledges 59.

Although the invention is being described with reference to a mobile phone, it should be understood that the invention can be used in any mobile electronic apparatus that includes a speaker, a such as PDAs, music or media players, portable radios, navigation devices, laptop computers and similar mobile electronic devices.

The invention has numerous advantages. Different embodiments or implementations may yield one or more of the following advantages. It should be noted that this is not an exhaustive list and there may be other advantages which are not described herein. One advantage of the invention is that it allows the construction of a very thin mobile apparatus with a powerful internal hands-free loudspeaker whilst keeping the strength of the magnetic field at the outer walls of the apparatus low. Another advantage of the invention is that it provides for an effective magnetic shielding that can be placed in a compact and thin apparatus. Yet another advantage of the invention is that it provides a magnetic shield includes openings for allowing passage of sound waves. It is also an advantage of the invention that it provides for an effective material for shielding magnetic fields generated by loudspeakers.

The term “comprising” as used in the claims does not exclude other elements or steps. The term “a” or “an” as used in the claims does not exclude a plurality.

Although the present invention has been described in detail for purpose of illustration, it is understood that such detail is solely for that purpose, and variations can be made therein by those skilled in the art without departing from the scope of the invention.

1. An electronic circuit carrier having at least a first and a second side, said sides facing away from each other, said circuit carrier comprising:
a speaker placed on a first side arranged with a first magnetic shielding plate and a
a second magnetic shielding plate arranged adjacent said second side.

2. An electronic circuit carrier according to claim 1, wherein at least one of said magnetic shielding plates comprises one or more openings allowing passage of the sound produced by said loudspeaker.

3. An electronic circuit carrier according to claim 1, wherein said magnetic shielding plate is arranged symmetrically relative to the magnetic field of the loudspeaker.

4. An electronic circuit carrier according to claim 2, wherein said openings are arranged symmetrically relative to the magnetic field of the loudspeaker or arranged such that the shielding plate with the openings is symmetrical to the speaker in its effect on the magnetic field of the speaker.

5. An electronic circuit carrier according to claim 1, wherein said magnetic shielding plate is made from an alloy comprising Ni and Fe.

6. An electronic circuit carrier according to claim 5, wherein said magnetic shielding plate alloy comprises 40 to 55% by weight Ni with the rest of the alloy being formed by Fe.

7-10. (canceled)

11. An electronic circuit carrier according to claim 1, wherein said first magnetic shielding plate is an integral part of the speaker.

12. An electronic circuit carrier according to claim 1, wherein at least one magnetic shielding plate is provided with ledges.

13-18. (canceled)

19. An electronic circuit carrier according to claim 1, wherein said electronic circuit carrier is a printed wire board or a flexible circuit board.

20. An apparatus comprising an electronic circuit carrier according to claim 1.

21. Apparatus according to claim 20, further comprising circuitry for generating a signal to drive said loudspeaker, said circuitry being configured to increase the strength of said signal to substantially offset a reduction in the magnetic field strength of said loudspeaker caused by the presence of said magnetic shielding plate.

22. An apparatus according to claim 20, wherein at least one magnetic shielding plate is an integral part of one of the outer walls of a housing of said apparatus.

23. An apparatus according to claim 22, wherein the housing comprises one or more cover parts and the magnetic shielding plate is an integral part of one of the covers.

24. A user removable cover for a mobile apparatus, said cover comprising an integral magnetic shielding plate.

25. A magnetic shielding plate for shielding the magnetic field of a loudspeaker, wherein said magnetic shielding plate is made of an alloy comprising 40 to 55% by weight Ni with reminder being mainly Fe.

26. A magnetic shielding plate for shielding the magnetic field of a loudspeaker with least one opening allowing passage of the sound produced by said loudspeaker.

27. A magnetic shielding plate according to claim 26, wherein said magnetic shielding plate comprises a plurality of openings allowing passage of the sound produced by said loudspeaker, said plurality of openings being symmetrically distributed over said magnetic shielding plate.

28. Use of a magnetic shielding plate for shielding a magnetic field of a speaker, wherein said magnetic shielding plate is made of an alloy comprising 40 to 55% by weight Ni with reminder being Fe.

29. A method for shielding a magnetic field that is generated by a speaker in a mobile apparatus having a housing with outer walls, comprising placing a magnetic shield between said speaker and one of said outer walls.
